(19) United States
(12) Patent Application Publication
(10) Pub. No.: US 2008/0044085 A1
(43) Pub. Date: Feb. 21, 2008

(54) METHOD AND APPARATUS FOR PLAYING BACK VIDEO, AND COMPUTER PROGRAM PRODUCT

(75) Inventor: Koji YAMAMOTO, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/687,772

(22) Filed: Mar. 19, 2007

(30) Foreign Application Priority Data
Aug. 18, 2006 (JP) 2006-223356

(51) Int. Cl. G06K 9/46

(52) U.S. Cl. 382/190

(57) ABSTRACT

A scene dividing unit divides input video data into scenes based on similarity of feature-information that represents a feature of a frame included in the video data. A scene grouping unit classifies the scenes into groups based on similarity of feature-information that represents a feature of a scene. A feature-scene selecting unit selects a feature scene that appears repeatedly in the video data. When a shift command is received, a playback-position control unit shifts a playback position to a frame of the feature scene that appears first after a current frame.

### CROSS-REFERENCE TO RELATED APPLICATIONS

This application is based upon and claims the benefit of priority from the prior Japanese Patent Application No. 2006-223356, filed on Aug. 18, 2006; the entire contents of which are incorporated herein by reference.

### BACKGROUND OF THE INVENTION

1. Field of the Invention

The present invention relates to a technology for playing back video, with a capability of skipping to a target position in response to an instruction from a user.

2. Description of the Related Art

Many video contents have been distributed recently with the development of the multichannel broadcasting and the information infrastructure. The spread of personal computers equipped with a hard disk recorder or a tuner allows some video recording devices to store video contents in a form of digital data and to analyze stored digital data, which makes it possible to provide various video watching systems.

For example, a technique based on similarity of scenes is used for analyzing video data. Similar scenes shot by a fixed camera appear frequently in video data of, for example, live broadcasts of a sports-game program. The similar scene is, for example, a pitching scene of the baseball or a scene of making a service in a tennis game. The similar scene is a start scene for each play and forms a semantic unit. It means that the video data can be browsed effectively in a short time using the semantic unit.

In a technique disclosed in JP-A 2003-283968 (KOKAI), scenes are grouped based on the similarity, and a representative frame of each group is displayed in a form of a list. When a user browses the list and selects a target group from the list, scenes in the selected group are displayed on a screen or played back sequentially to show a digest of the group.

In a technique for grouping the scenes based on the similarity disclosed in JP-A 2004-336556 (KOKAI) discloses, the scenes are allocated a same identification number for each group, and a sequence of the identification numbers is compare with data stored in a database. If a specific pattern is found from a result of the comparison, a group of scenes corresponding to the specific pattern is detected as a group having an event (for example, a home run).

However, in the technique disclosed in JP-A 2003-283968 (KOKAI), if the video data relate to a baseball-game program, the user will select a group including the pitching scene as the target group from the list of representative frames, every time the user hopes to skip unnecessary scenes. The video playback apparatus needs to display a selection screen in addition to a main screen, which causes an interface and an operation complicated.

If the user is not used to handling the video playback apparatus, it is difficult to search and select the target scene from a large number of scenes.

In the technique disclosed in JP-A 2004-336556 (KOKAI), it is required to register patterns of the sequences of identification numbers corresponding to combinations of the pitching scene and a scene immediately after the pitching scene. Various results of a battering make the scene immediately after the pitching scene so various that it is difficult to predict all the patterns. As a result, the created database cannot cover all the patterns, and some scenes that the user hopes to watch cannot be detected.

### SUMMARY OF THE INVENTION

An apparatus for playing back a video according to one aspect of the present invention includes a first feature information calculating unit that calculates a first feature information representing a feature of each of frames of input video data; a scene dividing unit that divides the input video data into scenes based on similarity of the first feature-information between the frames; a second feature information calculating unit that calculates a second feature-information representing a feature of each of the scenes; a scene grouping unit that classifies the scenes into groups based on similarity of second feature-information between scenes; a feature-scene selecting unit that selects a feature scene that appears repeatedly in the video data; an input receiving unit that receives a shift command; and a playback-position control unit that shifts, when the shift command is received, a playback position to a frame of the feature scene that appears first after a current frame.

A method of playing back a video according to another aspect of the present invention includes calculating a first feature information representing a feature of each of frames of input video data; dividing the input video data into scenes based on similarity of the first feature-information between the frames; calculating a second feature-information representing a feature of each of the scenes; classifying the scenes into groups based on similarity of second feature-information between scenes; selecting a feature scene that appears repeatedly in the video data; receiving a shift command; and shifting, when the shift command is received, a playback position to a frame of the feature scene that appears first after a current frame.

A computer program product according to still another aspect of the present invention includes a computer-usable medium having computer-readable program codes embodied in the medium that when executed cause a computer to execute calculating a first feature information representing a feature of each of frames of input video data; dividing the input video data into scenes based on similarity of the first feature-information between the frames; calculating a second feature-information representing a feature of each of the scenes; classifying the scenes into groups based on similarity of second feature-information between scenes; selecting a feature scene that appears repeatedly in the video data; receiving a shift command; and shifting, when the shift command is received, a playback position to a frame of the feature scene that appears first after a current frame.

### BRIEF DESCRIPTION OF THE DRAWINGS

FIG. 1 is a functional block diagram of a video playback apparatus according to a first embodiment of the present invention;

FIG. 2 is a schematic of an operation for playback video data relating to live broadcasts of a baseball game;

FIG. 3 is a schematic for explaining a process for extracting a feature amount;

FIG. 4 is a table for explaining an example of feature-scene data;

FIG. 5 is a general flowchart of a video playback process according to the first embodiment;

FIG. 6 is a flowchart of a scene dividing process according to the first embodiment;

FIG. 7 is a flowchart of a scene grouping process according to the first embodiment;

FIG. 8 is a flowchart of a feature-scene selecting process according to the first embodiment;

FIG. 9 is a flowchart of a target position calculating process according to the first embodiment;

FIG. 10 is a functional block diagram of a video playback apparatus according to a modification of the first embodiment;

FIG. 11 is a schematic for explaining a process of extracting a feature amount of a frame according to the modifications of the first embodiment;

FIG. 12 is a flowchart of a scene dividing process according to a first modification of the first embodiment;

FIG. 13 is a flowchart of a feature-scene selecting process according to a second modification of the first embodiment;

FIG. 14 is a flowchart of a target position selecting process according to a third modification of the first embodiment;

FIG. 15 is a functional block diagram of a video playback apparatus according to a second embodiment of the present invention;

FIG. 16 is a table for explaining an example of a shift table;

FIG. 17 is a table for explaining another example of the shift table;

FIG. 18 is a flowchart of a target position selecting process according to the second embodiment;

FIG. 19 is a functional block diagram of a video playback apparatus according to a third embodiment of the present invention;

FIG. 20 is a schematic for explaining an example where a first feature scene until whose next feature scene a cheer is given as a typical feature scene;

FIG. 21 is a schematic for explaining an example where the typical feature scene is selected using a feature amount based on time distribution;

FIG. 22 is a schematic for explaining an example where the typical feature scene is selected using another feature amount based on the time distribution;

FIG. 23 is a general flowchart of a video playback process according to the third embodiment;

FIG. 24 is a flowchart of a typical feature-scene selecting process according to the third embodiment; and

FIG. 25 is a hardware configuration of a video playback apparatus according to the present invention.

### DETAILED DESCRIPTION OF THE INVENTION

Exemplary embodiments of the present invention are described in detail below with reference to the accompanying drawings.

A video playback apparatus 100 according to a first embodiment of the present invention plays back video data recorded on a storage medium, such as a digital versatile disk (DVD) and a hard disk drive (HDD), or video data distributed via a network. The video data is composed of a plurality of frames including video and audio in most cases.

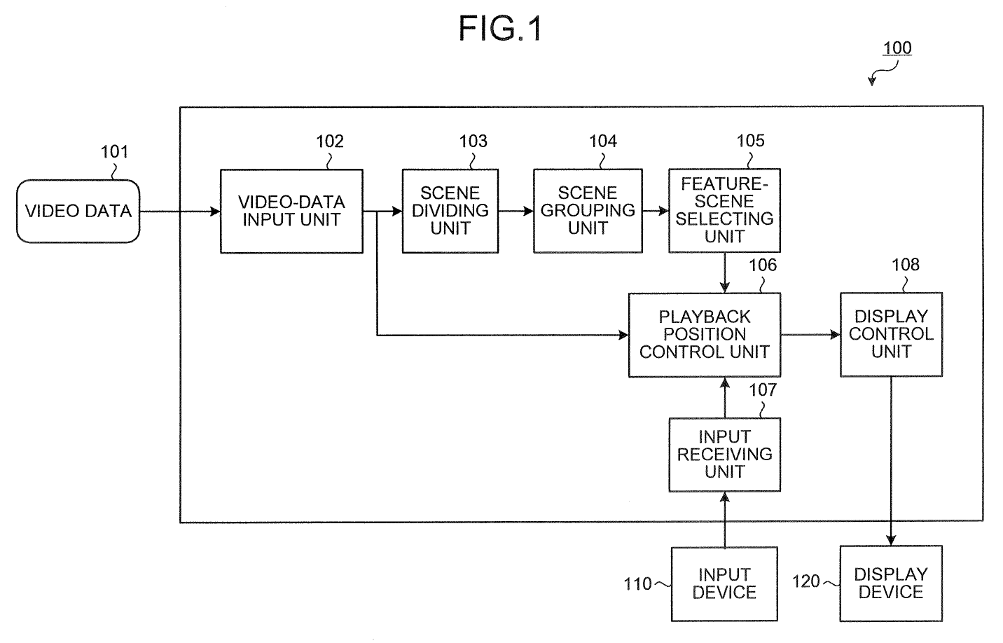

As shown in FIG. 1, the video playback apparatus 100 includes a video-data input unit 102, a scene dividing unit 103, a scene grouping unit 104, a feature-scene selecting unit 105, a playback-position control unit 106, an input receiving unit 107, a display control unit 108, an input device 110 such as a keyboard, a mouse, or a remote controller with various buttons, and a display device 120.

The video-data input unit 102 inputs video data 101 to the video playback apparatus 100. The video data 101 is recorded on a storage medium, such as a DVD and an HDD, or received via a network.

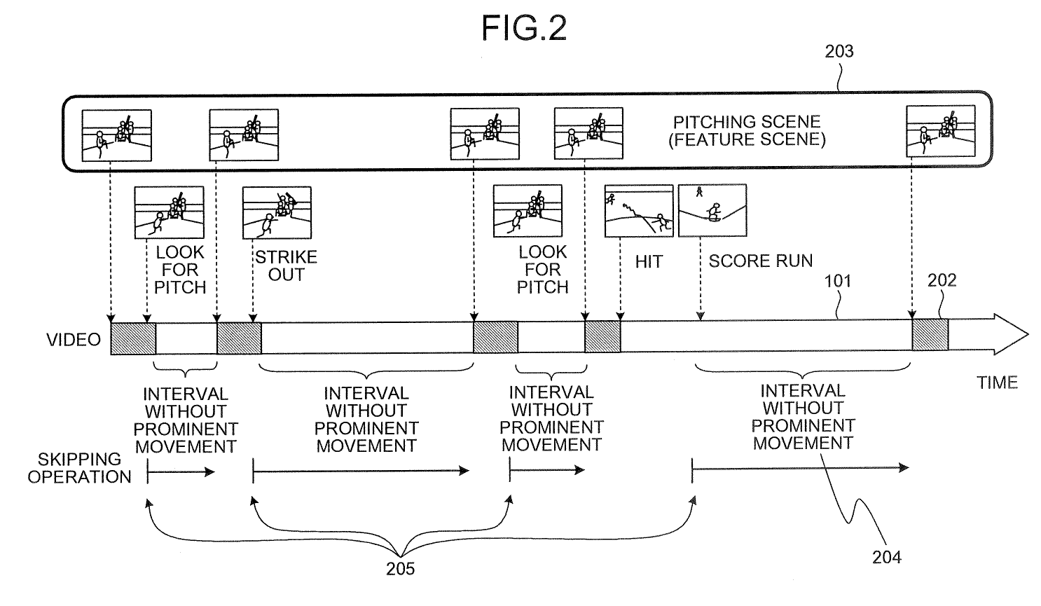

An overview of a process in which the video playback apparatus 100 plays back the video data 101 is described below with reference to FIG. 2. FIG. 2 is a schematic of an operation for playback video data relating to live broadcasts of a baseball game. Time is passing from left to right in the video data 101. Shaded portions 202 represent a pitching scene that is shot from a position behind a pitcher aiming at a batter. The pitching scene shot by a camera with the same position and angle appears almost every time of pitching. In other words, the pitching scene appears several times during the baseball-game program. A scene that appears several times in video data, like the pitching scene, is regarded as a feature scene.

Frames 203 are head frames of the pitching scene, which is the feature scene in the video data of the baseball-game program. Generally, a baseball game is composed of a plurality of plays starting from a pitching and ending with a result of a batting. There is no prominent movement during an interval between the plays. The interval means, for example, a period between pitches for each batter, a period for switching batters after an out or switching teams after a third out, or a period when people is excited about scoring a run until a next batter steps to a bat. If the interval can be skipped, the total time required for watching the video data can be considerably reduced. Time points 205 represent points when a user, who determines that the game doesn't move, inputs a skip instruction. Upon receiving the instruction for skipping from the user, the video playback apparatus 100 skips frames corresponding to the interval, which represented by an arrow in FIG. 2, and plays back the next pitching scene. As described above, because the video playback apparatus 100 skips to the next feature scene, when receiving the instruction for skipping, the user can browse the video data based on a semantic unit such as the pitching scene.

The video playback apparatus 100 does not automatically skip to the next scene. Because the skipping operation depends on the user decision, the user can keep watching the video data, if the user hopes. The video playback apparatus 100 does not skip scenes that the user hopes to watch. Therefore, the video playback apparatus 100 enables the user to browse video data under the user initiative than in a digest playback method, in which scenes are automatically skipped.

The functional configuration of the video playback apparatus 100 is described in detail below with reference to FIG. 1. The scene dividing unit 103 extracts a feature amount (first feature-information) of a frame included in the video data 101, and divides the video data 101 into scenes based on a similarity of the feature amounts (the first feature-information) between the frames. Each scene is made up of a plurality of frames.

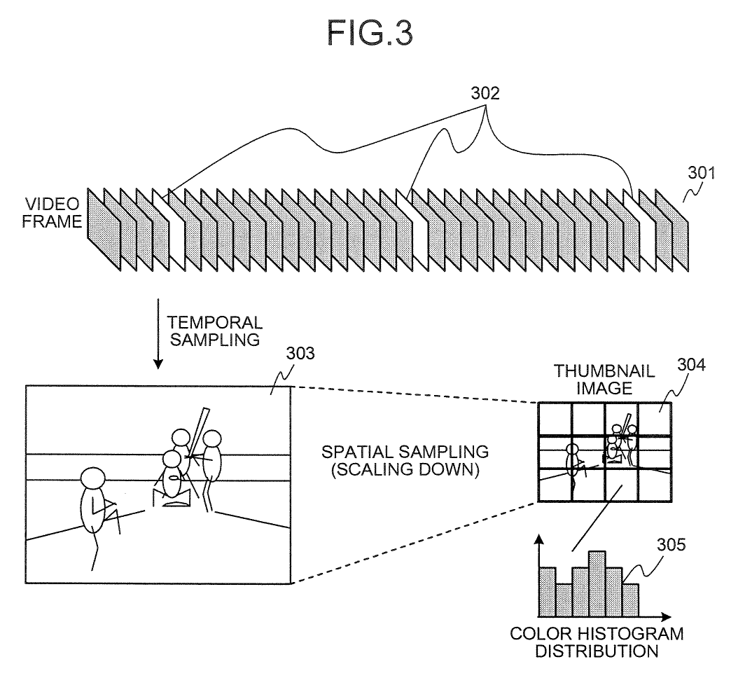

A process in which the scene dividing unit 103 extracts the feature amount is described below with reference to FIG. 3.

Frames 301 are frames in the video data 101 arranged sequentially. Although it is possible to extract the feature amount from each of the frames 301, the scene dividing unit 103 extracts the feature amount after sampling based on the time order or the spatial order to reduce a volume to be processed. In the temporal sampling, the scene dividing unit 103 samples some sample frames 302 from the frames 301. More particularly, the scene dividing unit 103 can sample the sample frames each of which is equally spaced in the time order, or extract only I-picture in an MPEG (moving pictures expert groups) video. A frame 303 is one of the sample frames 302. The scene dividing unit 103 creates a thumbnail image 304 in the spatial sampling by scaling down the frame 303. More particularly, the scene dividing unit 103 can create the thumbnail image 304 by scaling down the frame 303 based on an average of a plurality of pixels or by calculating decoded DC components of a discrete cosine transform (DCT) coefficient of an I-picture in MPEG. The scene dividing unit 103 divides the thumbnail image 304 into a plurality of blocks, and obtains a color histogram distribution 305 for each block. The color histogram distribution 305 represents the feature amount of the frame 303.

The process in which the scene dividing unit 103 divides the video data into scenes based on the similarity of the feature amounts between the frames is described below. The scene dividing unit 103 divides the video data 101 into scenes based on the similarity obtained by comparing the feature amounts between two frames of the sample frames 302 sampled based on the time order. More particularly, the scene dividing unit 103 calculates a distance between the feature amounts of the two frames. When the distance is smaller than a first threshold, the two frames are determined to be similar and included in a same scene. When the distance is larger than the first threshold, the two frames are determined to be dissimilar, and each of the frames is included in a different scene. By processing all the sample frames 302, the frames are grouped and the video data 101 is divided into scenes.

As the distance of the feature amounts, for example, the Euclidian distance is employed. If b^{th} frequency of a^{th} block in a color histogram of a frame i is “h (a, b)”, the Euclidian distance “d” is calculated by

$${d}^{2} = {\sum }_{a} {\sum }_{b} {( {h}_{i} ( a , b ) - {h}_{i + 1} ( a , b ) )}^{2} \qquad ( 1 )$$

The scene grouping unit 104 in FIG. 1 is a processing unit that extracts a feature amount that represents a feature of a scene (second feature-information) and groups the scenes based on a similarity of the feature amounts between the scenes to create a group including a plurality of scenes. More particularly, the scene grouping unit 104 uses the feature amount of a head frame of each scene. When the Euclidean distance between the feature amounts of any two of the scenes is smaller than a second threshold, the two scenes are determined to be similar and belonging to a same group. When the Euclidean distance of the two scenes is larger than the second threshold, the two scenes are determined to be dissimilar and each of the two scenes is belonging to a different group. By processing all the scenes, groups to which a similar scene belongs are sequentially integrated, and all the scenes are grouped as a result.

Although the feature amounts of the head frames of the scenes are used for grouping the scenes according to the first embodiment, the feature amount is not limited to above. The feature amount of any of the frames in the scene can be used.

The feature-scene selecting unit 105 is a processing unit that determines whether a frequency of the appearance of scenes belonging to a group satisfies the first criterion, selects the scenes with the frequency that satisfies the first criterion as feature scenes, arranges all the feature scenes in the time order, and stores the arranged feature scenes (hereinafter “feature-scene data”) in a storage medium such as a memory. The feature scene that appears with frequency, satisfying the first criterion, forms a semantic unit of the video data.

More particularly, the feature-scene selecting unit 105 obtains the number of scenes belonging to a group, a sum of playback times of the scenes belonging to the group, a ratio of the number of the scenes belonging to the group to the total number of scenes in the video data 101, or a ratio of the sum of playback times of the scenes belonging to the group to the total playback time of the video data 101, and checks whether the obtained value is equal to or larger than a threshold that is defined as the first criterion.

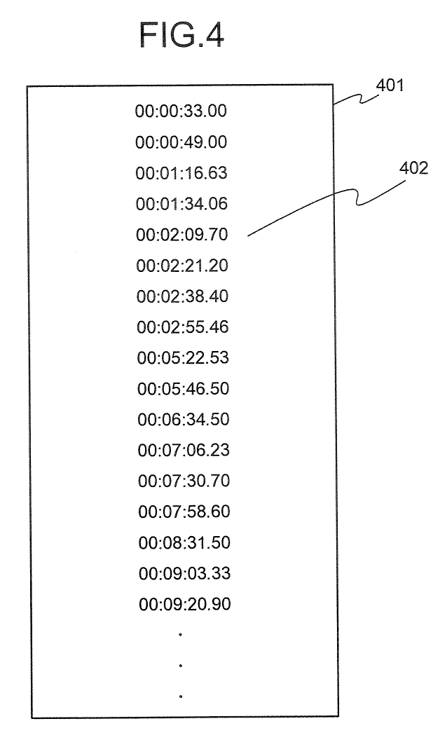

As shown in FIG. 4, feature-scene data 401 includes times of head frames of the feature scenes arranged in the time order. If each of the frames can be specified, a frame number can be used instead of the frame time.

The input receiving unit 107 is a processing unit that receives an instruction that is input by a user using the input device 110 as an event or the like. The input receiving unit 107 receives an instruction for skipping from the user via the input device 110 as an event or the like.

The playback-position control unit 106 is a processing unit that shifts a playback position to a frame of a feature scene that appears first after a frame at a current playback position.

If a playback time of the current frame is at 00:02:00.00, a target position to which the playback position is shifted is a feature scene 402 that appears first after a current frame. It is allowable to set the target position to a position shifted forward or backward from the head frame of the feature scene by a predetermined time or a predetermined number of frames.

The display control unit 108 is a processing unit that controls various data displayed on the display device 120. More particularly, the display control unit 108 displays the video data 101 on the display device 120 played back from the target position controlled by the playback-position control unit 106.

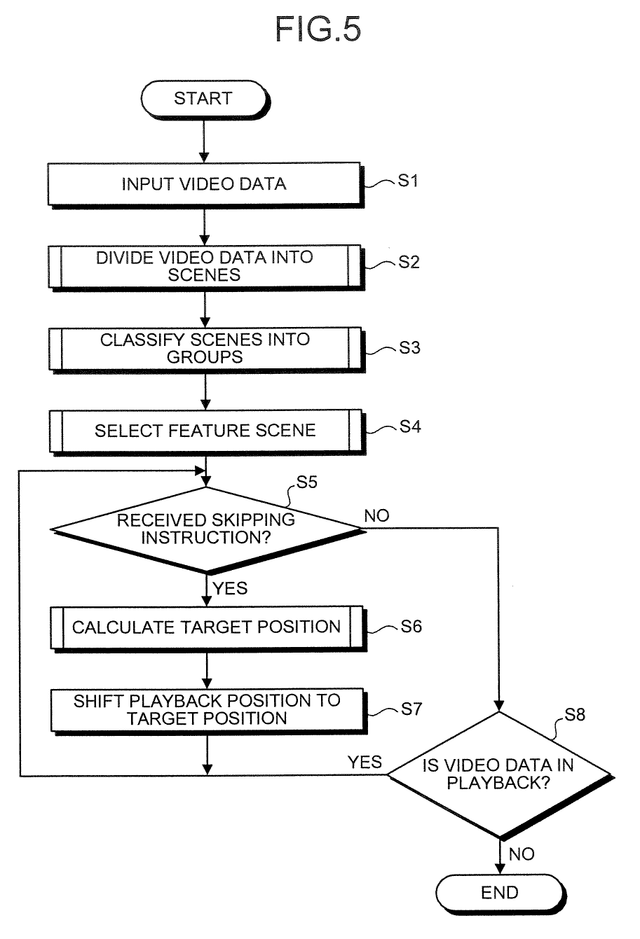

A video playback process by the video playback apparatus 100 is described below with reference to FIG. 5.

The video-data input unit 102 inputs the video data 101 (step S1). The scene dividing unit 103 extracts the feature amount of a frame in the video data 101, and divides the video data 101 into scenes each of which is a collection of serial frames with a similar feature amount (step S2). The scene grouping unit 104 extracts the feature amount of a scene, and classifies the scenes into groups based on the similarity between the extracted feature amounts of the scenes (step S3). The feature-scene selecting unit 105 selects a group that includes a scene with a frequency that satisfies the first criterion and sets the scene belonging to the selected group to the feature scene (step S4). The input receiving unit 107 checks whether the instruction for skipping has been received (step S5). When the instruction for skipping has been received (Yes at step S5), the playback-position control unit 106 calculates the target position by referring to the feature-scene data (step S6), and shifts the playback position to a target position calculated at step S6 (step S7).

When the instruction for skipping has not been received (No at step S5), whether the video data 101 is in playback is checked (step S8). When the video data 101 is not in playback (No at step S8), the process ends. When the video data 101 is in playback (Yes at step S8), the process returns to step S5.

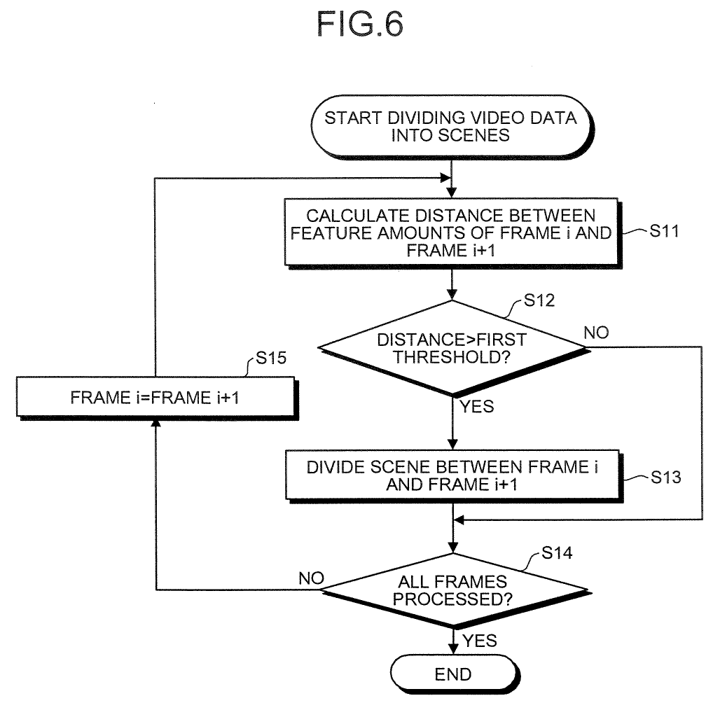

The scene dividing process at step S2 is described below with reference to FIG. 6. In a flowchart shown in FIG. 6, “i” is an integral number ranging from 1 to N (an initial value of i is 1), representing a frame to be processed, where N is the total number of the frames to be processed. The frames to be processed are sampled based on the time order.

The scene dividing unit 103 extracts feature amounts of a frame i and a frame i+1 to calculate an Euclidean distance between the two frames by Equation (1) (step S11), and checks whether the Euclidean distance is larger than the first threshold (step S12). When the Euclidean distance is larger than the first threshold, the scene dividing unit 103 determines that the two frames are dissimilar and makes a scene by cutting between the frame i and the frame i+1 (step S13). That is, the frame i belongs to a scene different from a scene to which the frame i+1 belongs.

When the Euclidean distance is equal to or smaller than the first threshold (No at step S12), the scene dividing unit 103 makes a scene including both the frame i and the frame i+1 without cutting between the frame i and the frame i+1.

The scene dividing unit 103 checks whether all the sample frames have been processed as described at steps S11 to S13 (step S14). When all the sample frames have not been processed, the frame i is set to the frame i+1 (step S15), and the scene dividing unit 103 repeats the process of steps S11 to S13. By processing all the sample frames as described at steps S11 to S13, all the frames are grouped and the video data 101 is divided into a plurality of scenes.

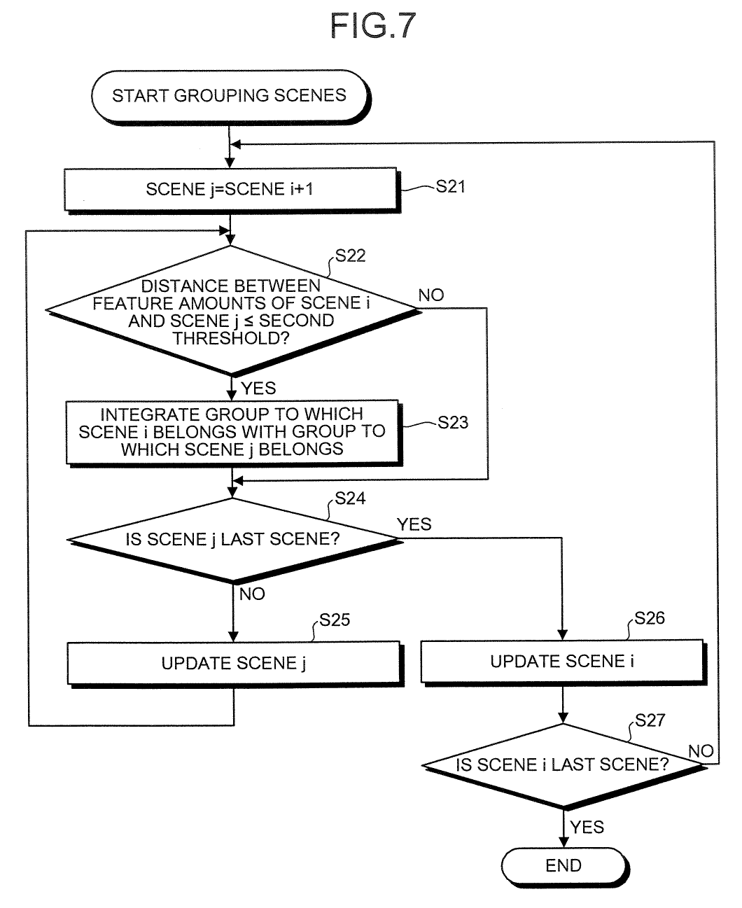

The scene grouping process by the scene grouping unit 104 at step S7 is described below with reference to FIG. 7. In a flowchart shown in FIG. 7, “i” is an integral number ranging from 1 to N (an initial value of i is 1), representing a scene to be processed, where N is the total number of the scenes to be processed.

The scene grouping unit 104 sets a scene j to a scene i+1 (step S21), extracts feature amounts of the scene i and the scene j (more particularly, the feature amount of a head frame for each scene), obtains a Euclidian distance between the feature amounts of the scene i and the scene j by Equation (1), and checks whether the Euclidian distance is equal to or smaller than the second threshold (step S22).

When the Euclidian distance is equal to or smaller than the second threshold (Yes at step S22), the scene grouping unit 104 determines that the scene i and the scene j are similar and integrates a group to which the scene i belongs with a group to which the scene j belongs (step S23).

When the Euclidian distance is larger than the second threshold (No at step S22), the scene grouping unit 104 determines that the scene i and the scene j are dissimilar and regards the group to which the scene i belongs and the group to which the scene j belongs as different groups, not integrating the two groups.

The scene grouping unit 104 checks whether the scene j is the last scene (step S24). When the scene j is not the last scene, that is, “j” is smaller than “N” (No at step S24), the scene grouping unit 104 updates the scene j by setting j to j+1 (step S25) and repeats the process of steps S22 to S24.

When the scene j is the last scene, that is, “j” is “N” (Yes at step S24), the scene grouping unit 104 updates the scene i by setting i to i+1 (step S26) to process the next scene. The scene grouping unit 104 checks whether the scene i is the last scene of the video data (step S27).

When the scene i is not the last scene (No at step S27), the scene grouping unit 104 repeats the process of steps S21 to S26. When the scene i is the last scene (Yes at step S27), the scene grouping unit 104 ends the process.

By the above process, groups having a similar scene are sequentially integrated, and all the scenes are grouped as a result.

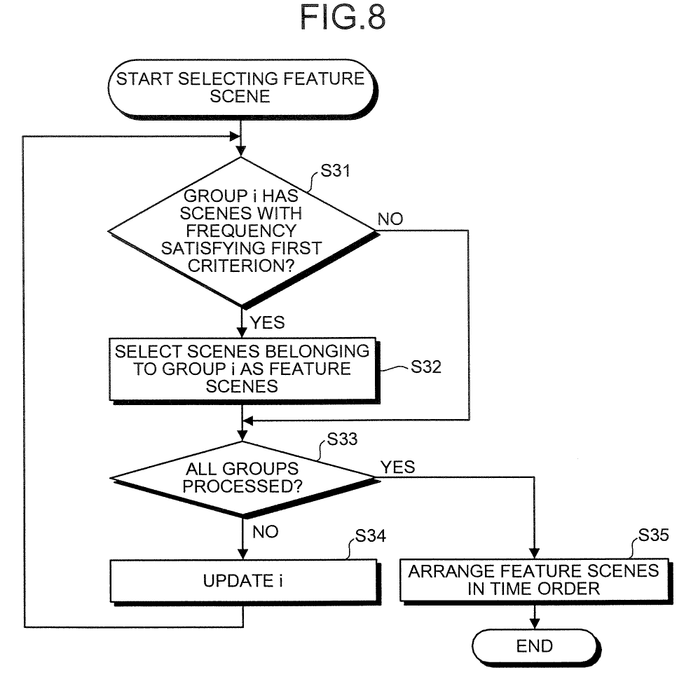

The feature-scene selecting process by the feature-scene selecting unit 105 at step S4 is described below with reference to FIG. 8. In a flowchart shown in FIG. 8, “i” is an integral number ranging from 1 to N (an initial value of i is 1), representing a group to be processed, where N is the total number of the groups.

The feature-scene selecting unit 105 checks whether a group i has scenes with a frequency that satisfies the first criterion (step S31). The frequency is, as described above for example, the number of scenes belonging to a group, a sum of playback times of the scenes belonging to the group, a ratio of the number of the scenes belonging to the group to the total number of scenes in the video data 101, or a ratio of the sum of playback times of the scenes belonging to the group to the total playback time of the video data 101. When the frequency is equal to or larger than a threshold that is defined as the first criterion, the feature-scene selecting unit 105 determines that the frequency satisfies the first criterion. When the frequency is smaller than the threshold, the feature-scene selecting unit 105 determines that the frequency does not satisfy the first criterion.

When the group i has scenes with the frequency that satisfies the first criterion (Yes at step S31), the feature-scene selecting unit 105 selects the scenes belonging to the group i as feature scenes (step S32). When the group i doesn't have the scene with the frequency that satisfies the first criterion (No at step S31), the feature-scene selecting unit 105 skips the step of selecting the feature scene.

The feature-scene selecting unit 105 checks whether all the groups have been processed as described at steps S31 to S33 (step S33). When all the groups have not been processed (No at step S33), the feature-scene selecting unit 105 updates i by setting i to i+1 (step S34) to process the next group as described at steps S31 to S33.

When the feature-scene selecting unit 105 determines that all the groups have been processed as described at steps S31 to S33 (Yes at step S33), the feature-scene selecting unit 105 arranges the feature scenes in the time order (step S35) to create the feature-scene data as shown in FIG. 4, stores the feature-scene data in a storage medium such as a memory, and ends the process. As a result of the above process, the feature scenes have been selected.

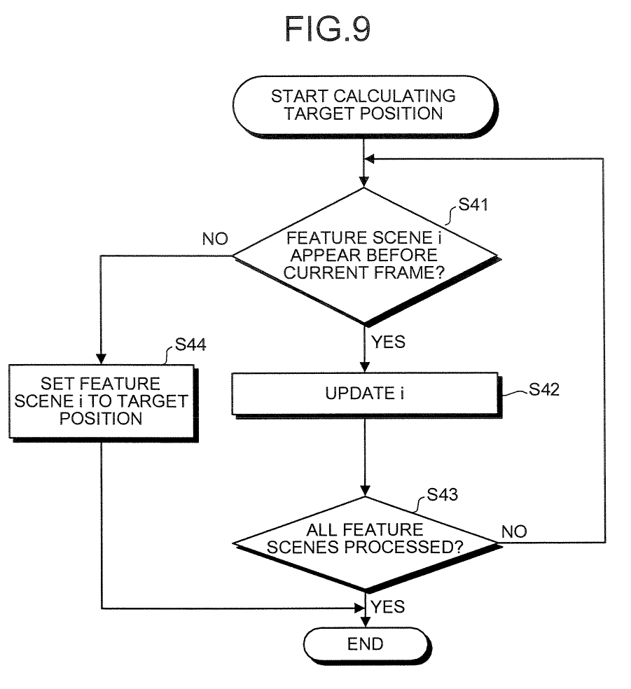

The target position calculating process by the playback-position control unit 106 at step S6 is described below with reference to FIG. 9. In a flowchart shown in FIG. 9, “i” is an integral number ranging from 1 to N (an initial value of i is 1), representing a feature scene to be processed, where N is the total number of the feature scenes.

The playback-position control unit 106 checks whether a feature scene i appears before a frame at a current playback position (that is, a current frame) (step S41). When the feature scene i appears after the current frame (No at step S41), the playback-position control unit 106 sets a head frame of the feature scene i to the target position (i.e., a position to which the playback position is shifted) (step S44).

When the feature scene i appears before the current frame (Yes at step S41), the playback-position control unit 106 updates i by setting i to i+1 (step S42) to process all the feature scenes as described at steps S41 and S42 (step S43).

As a result, the target position is determined and the video data 101 is played back from the target position at step S7.

The video playback apparatus 100 enables the user to browse the video data by skipping to the feature scene, which is the beginning of the next semantic unit, with an input operation of pushing a skip button provided at the input device 110 while watching the video data. The video playback apparatus 100 can play back the video data from a proper position in a short time.

In the example of the video data of the baseball-game program, the pitching scene can be selected as the feature scene. When the user finds a result of a pitch, such as looking for a pitch, strikeout, or hit, the user can skip the interval, where the game doesn't move, to the next pitching scene in a short time. Because all the user has to do is pressing a button corresponding to the instruction for skipping, even if the user is not used to handling the video playback apparatus, it is easy to handle the video playback apparatus 100. Because the skipping operation depends on the user decision, the video playback apparatus 100 enables the user to browse video under the user initiative, dislike in the conventional digest playback method, in which some scenes are automatically skipped.

Modifications of the video playback apparatus 100 according to the first embodiment are described below.

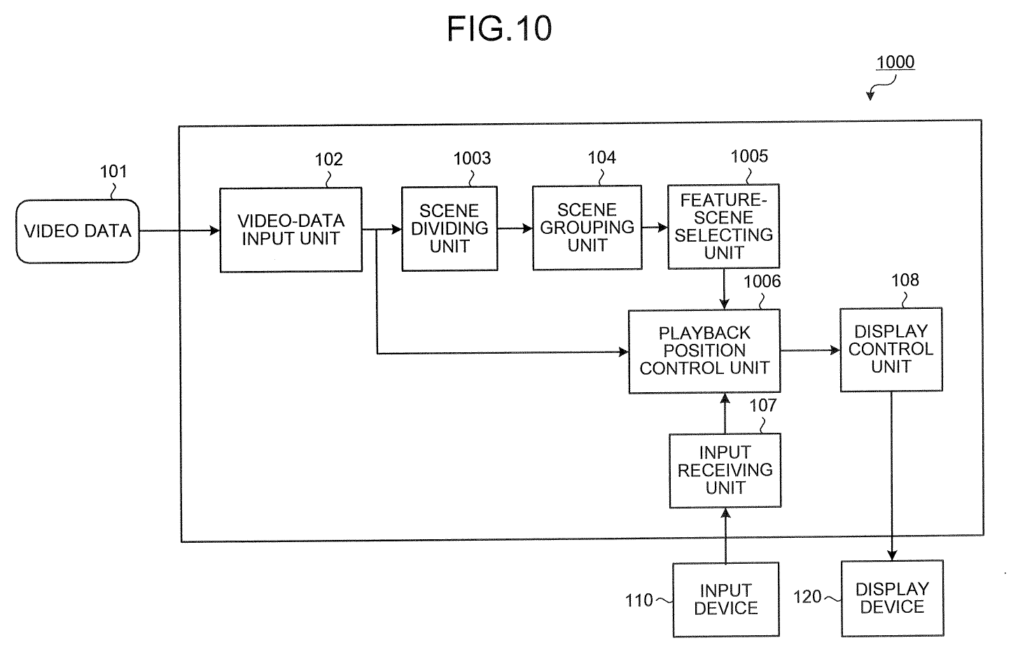

As shown in FIG. 10, a video playback apparatus 1000 according to a modification of the first embodiment includes the video-data input unit 102, a scene dividing unit 1003, the scene grouping unit 104, a feature-scene selecting unit 1005, a playback-position control unit 1006, the input receiving unit 107, the display control unit 108, the input device 110 such as a remote controller with various buttons, and the display device 120. The functions and the configuration of the video-data input unit 102, the input receiving unit 107, the scene grouping unit 104, the display control unit 108, the input device 110, and the display device 120 are similar to those according to the first embodiment.

The scene dividing process by the scene dividing unit 1003 according to a first modification of the first embodiment is dissimilar to that according to the first embodiment.

The scene dividing unit 1003 determines whether feature amounts of two frames satisfy a second criterion. When the feature amounts don't satisfy the second criterion, the two frames are belongs to different scenes. When the feature amounts satisfy the second criterion, the two frames belong to the same scene.

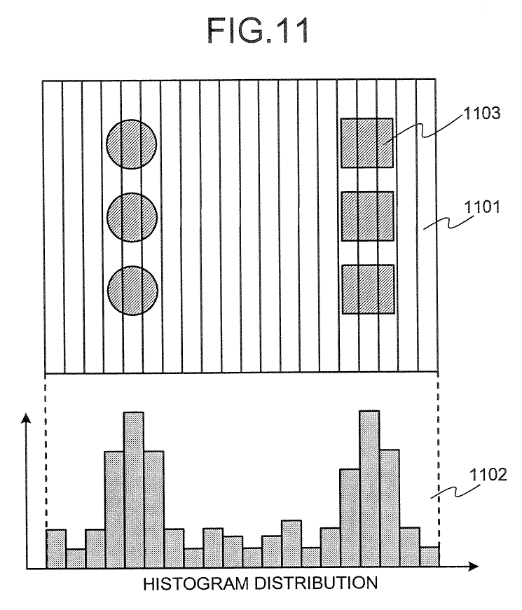

A process for extracting the feature amount of a frame according to the first modification is described below. As shown in FIG. 11, the scene dividing unit 1003 divides the thumbnail image 304 shown in FIG. 4 in the vertical direction as shown an image 1101. The scene dividing unit 1003 counts the number of pixels that satisfy a predetermined color condition for each area, obtains a histogram distribution 1102, and regards a sum of frequencies represented in the histogram distribution 1102, in other words a ratio of a specific color in the entire frame, as a feature amount. The feature amount is not limited to the sum of the frequencies.

If the image 1101 has tickers 1103 with texts in white vertically arranged on the right and the left side, and the histogram distribution 1102 represents the number of white pixels brighter than a predetermined value, the histogram distribution 1102 has two peaks at the left and the right side. Although the thumbnail image is vertically divided, the dividing way is not limited to above. It is allowable to divide the thumbnail image horizontally or in lattice-shaped.

The scene dividing unit 1003 determines whether the feature amount extracted as described above satisfies the second criterion. When the sum of the frequencies represented in the histogram, in other words the ratio of the specific color in the entire frame, is equal to or larger than a predetermined value, the scene dividing unit 1003 determines that the feature amount satisfies the second criterion. The scene dividing unit 1003 determines that a frame that satisfies the second criterion is similar to one that satisfies the second criterion and dissimilar to one that doesn't satisfy the second criterion, and makes a scene by cutting between a frame that satisfies the second criterion and another frame that doesn't satisfy the second criterion.

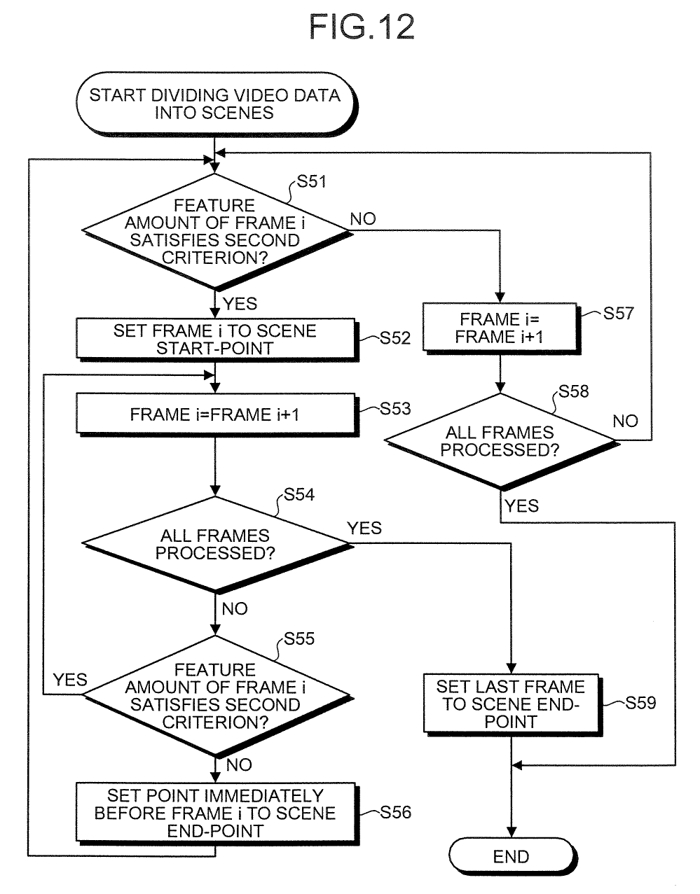

The scene dividing process by the scene dividing unit 1003 is described below with reference to FIG. 12. In a flowchart shown in FIG. 12, “i” is an integral number ranging from 1 to N (an initial value of i is 1), representing a frame to be processed, where N is the total number of the frames to be processed.

The scene dividing unit 1003 extracts a feature amount of a frame i as described above, and determines whether the extracted feature amount satisfies the second criterion (step S51). In other words, the scene dividing unit 1003 determines whether a ratio of the specific color in the entire frame i is equal to or larger than the predetermined value.

When the feature amount of the frame i doesn't satisfies, which means that the ratio of the specific color in the entire frame i is smaller than the predetermined value, the second criterion (No at step S51), sets i to i+1 to process the next frame (step S57). The scene dividing unit 1003 checks whether all the frames have been processed as described at steps S51 and S57 (step S58). When all the frames have not been processed, the scene dividing unit 1003 returns the process to step S51 to process the next frame in the similar way.

When all the frames have been processed as described at steps S51 and S57 (Yes at step S58), the scene dividing unit 1003 ends the process.

When the feature amount of the frame i satisfies the second criterion (Yes at step S51), which means that the ratio of the specific color in the entire frame i is equal to or larger than the predetermined value, the frame i is set to a start point of a scene (step S52). The scene dividing unit 1003 sets i to i+1 to process the next frame. The scene dividing unit 1003 checks whether all the frames have been processed. When all of the frames have been processed, the scene dividing unit 1003 sets the last frame to an end point of the scene (step S59).

When all the frames have not been processed, the scene dividing unit 1003 determines whether the next frame (frame i) satisfies the second criterion (step S55). When the frame i satisfies the second criterion (Yes at step S55), the scene dividing unit 1003 repeats the process of steps S53 and S54.

When the frame i doesn't satisfy the second criterion (No at step S55), the scene dividing unit 1003 determines that the frame i is dissimilar to the frame immediately before the frame i, sets the frame immediately before the frame i to an end point of a scene (step S56), and returns the process to step S51.

By processing described above, the frames are grouped and the video data is divided into scenes.

A feature-scene selecting process by the feature-scene selecting unit 1005 according to a second modification of the first embodiment is dissimilar to that according to the first embodiment.

The feature-scene selecting unit 1005 determines whether scenes belonging to a group has a frequency that satisfies the first criterion, and further determines whether a time-distribution overlap between the scenes having the frequency that satisfies the first criterion and scenes belonging to another group that has been selected as the feature scenes satisfies the third criterion. When the overlap satisfies the third criterion, the feature-scene selecting unit 1005 selects the scenes having the frequency that satisfies the first criterion as the feature scene. The first criterion is, for example, whether the number of the scenes belonging to the group is larger than a threshold or whether a ratio of a sum of playback times of the scenes belonging to the group to the total playback time of the video data is larger than a predetermined value.

The overlap is determined based on the third criterion described as follows. “tᵢ1 to tᵢ2” (seconds) represents a range where scenes belonging to a group i are distributed. “tⱼ1 to tⱼ2” (seconds) represents a range where scenes belonging to a group j are distributed. “sᵢ” is the number of scenes belonging to the group i distributed in tⱼ1 to tⱼ2, and “sⱼ” is the number of scenes belonging to the group j distributed in tᵢ1 to tᵢ2. “S” is the number of overlapped scenes and is obtained by adding sᵢ and sⱼ. When S is equal to or smaller than a threshold, it is determined that the overlap satisfies the third criterion.

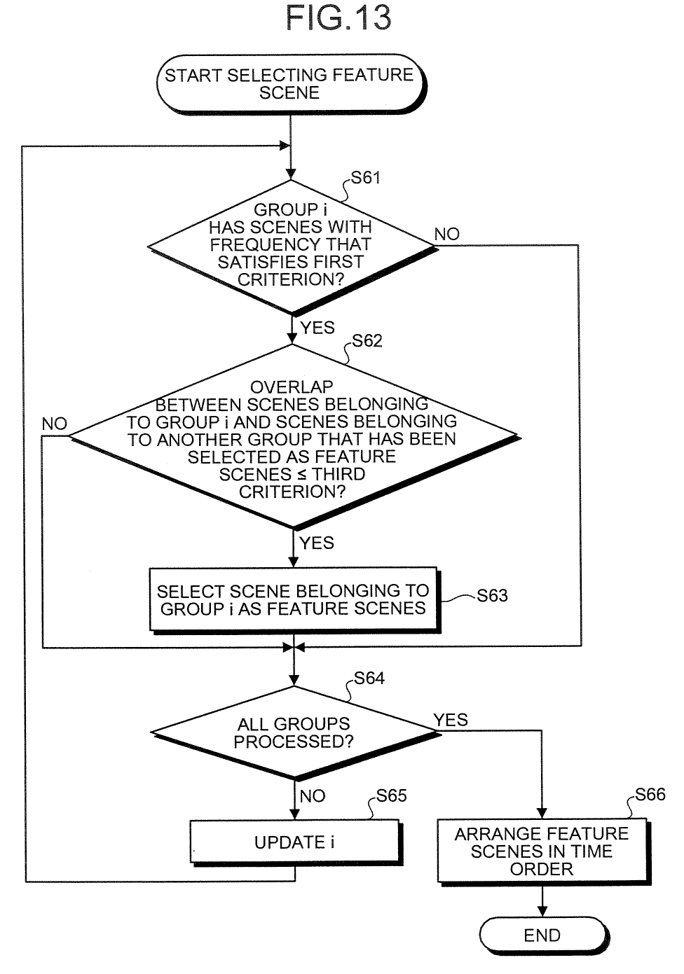

The feature-scene selecting process according to the second modification is described with reference to FIG. 13. In a flowchart shown in FIG. 13, “i” is an integral number ranging from 1 to N (an initial value of i is 1), representing a group to be processed, where N is the total number of the groups to be processed.

The feature-scene selecting unit 1005 checks whether the group i has scenes with a frequency that satisfies the first criterion (step S61). When the group i doesn't have the scenes with a frequency that satisfies the first criterion (No at step S61), the feature-scene selecting unit 1005 skips the process of selecting the feature scenes and proceeds to step S64.

When the group i has the scenes with a frequency that satisfies the first criterion (Yes at step S61), the feature-scene selecting unit 1005 checks whether the overlap between the scenes belonging to the group i and scenes belonging to another group that has been selected as the feature scenes satisfies the third criterion, which means the overlap is equal to or smaller than the threshold (step S62). When the overlap doesn't satisfy the third criterion, which means that the overlap is larger than the threshold (No at step S62), the process proceeds to step S64.

When the overlap satisfies the third criterion, which means the overlap is equal to or smaller than the threshold (Yes at step S62), the feature-scene selecting unit 1005 selects the scenes belonging to the group i as the feature scenes (step S63).

The feature-scene selecting unit 1005 checks whether all the groups have been processed as described at steps S61 to S63 (step S64). When all the groups have not been processed, the feature-scene selecting unit 1005 updates i by setting i to i+1 (step S65) to process the next group as described at steps S61 to S63. When all the groups have been processed as described at steps S61 to S63, the feature-scene selecting unit 1005 arranges the feature scenes in the time order (step S66) to create the feature-scene data shown in FIG. 4, stores the feature-scene data in the storage medium, and ends the process. As a result of the process, the feature scenes have been selected.

A target position calculating process by the playback-position control unit 1006 according to a third modification of the first embodiment is dissimilar to that according to the first embodiment.

Upon receiving the instruction for skipping, the playback-position control unit 1006 selects a feature scene that appears first after the current frame. When a scene immediately before the selected feature scene has a frequency that satisfies a fourth criterion, the playback-position control unit 1006 shifts the playback position to the scene immediately before the selected feature scene. The first criterion is similar to that described in the first embodiment. The fourth criterion is, for example, whether the number of scenes belonging to a group larger than a threshold, or whether a ratio of a sum of playback times of the scenes belonging to the group to the total playback time of the video data is larger than a predetermined value.

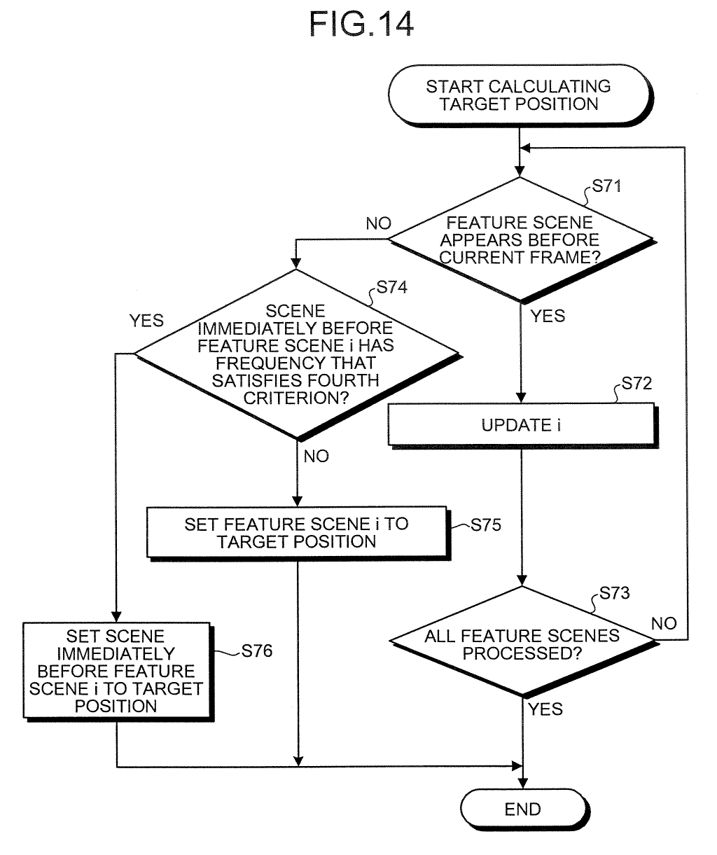

The target position calculating process by the playback-position control unit 1006 is described with reference to FIG. 14. In a flowchart shown in FIG. 14, “i” is an integral number ranging from 1 to N (an initial value of i is 1), representing a feature scene to be processed, where N is the total number of the scenes to be processed.

The playback-position control unit 1006 checks whether a feature scene i appears before the current frame (step S71). When the feature scene i appears after the current frame (No at step S71), the playback-position control unit 1006 checks whether a scene immediately before the feature scene i has a frequency that satisfies the fourth criterion (step S74). When the scene immediately before the feature scene i has a frequency that doesn't satisfy the fourth criterion (No at step S74), the playback-position control unit 1006 sets a head frame of the feature scene i to the target position (i.e., a position to which the playback position is shifted) (step S75).

When the scene immediately before the feature scene i has a frequency that satisfies the fourth criterion (Yes at step S74), the playback-position control unit 1006 sets a head frame of the scene immediately before the feature scene to the target position (i.e., a position to which the playback position is shifted) (step S76)

When the feature scene i appears before the current frame (Yes at step S71), the playback-position control unit 1006 updates the feature scene i by setting i to i+1 (step S72) to process all the feature scenes as described at steps S71 and S72 (step S73).

As a result of the above process, the target position has been determined and the video data is skipped to the target position at step S7.

Although the scene immediately before the feature scene is determined as described at step S74 according to the third modification, a scene two or more scenes before the feature scene can be set to the target position by checking a frequency of a scene before the feature scene one after another going backward.

A video playback apparatus 1500 according to a second embodiment of the present invention is described below. The video playback apparatus 1500 sets a position shifted from the feature scene by a shift amount depending on a type of video contents to the target position.

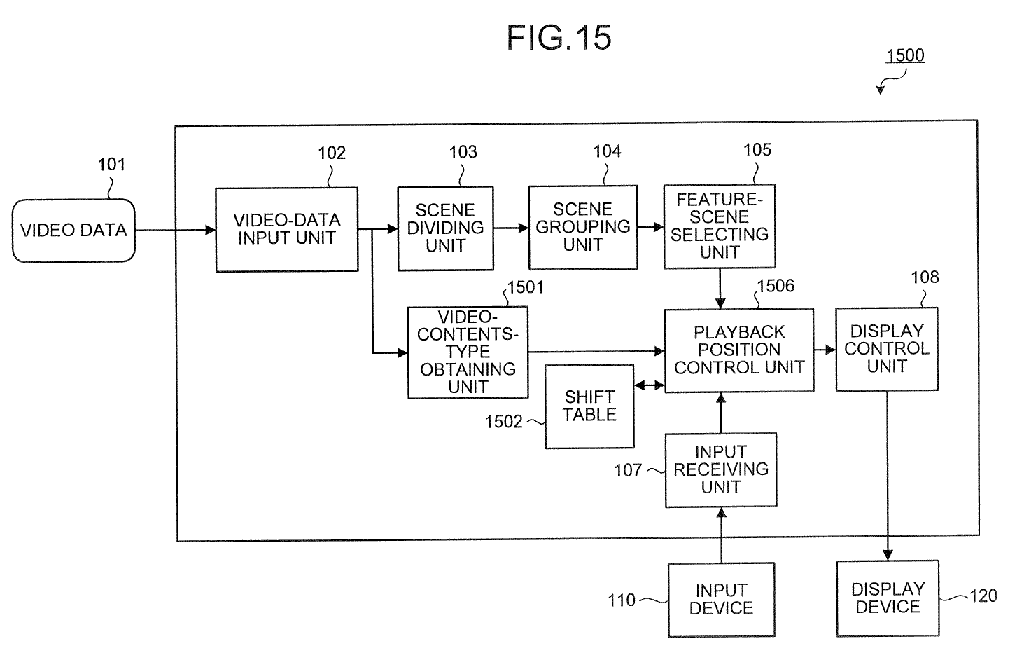

As shown in FIG. 15, the video playback apparatus 1500 includes the video-data input unit 102, the scene dividing unit 103, the scene grouping unit 104, the feature-scene selecting unit 105, a playback-position control unit 1506, a video-contents obtaining unit 1501, the input receiving unit 107, a shift table 1502, the display control unit 108, the input device 110 such as a keyboard, a mouse, or a remote controller with various buttons, and the display device 120.

The functions and the configuration of the video-data input unit 102, the scene dividing unit 103, the scene grouping unit 104, the feature-scene selecting unit 105, the input receiving unit 107, the display control unit 108, the input device 110, and the display device 120 are similar to those according to the first embodiment.

The video-contents obtaining unit 1501 is a processing unit that obtains a type of video contents for video data that is input to the video playback apparatus 1500. The types of video contents are, for example, types of programs. If the video data relates to a sports program, the type of video contents can be the baseball, the soccer, the tennis, or the like. More particularly, when the video data is recorded using a program such as an electronic program guide (EPG), the video-contents obtaining unit 1501 can obtain the type of video contents by reading a booking data such as EPG-programmed data stored in a storage medium.

The shift table 1502 relates a type of video contents to a shift amount counted from the feature scene and is prestored in a storage medium such as a memory or a HDD. The shift amount can be represented by any unit, such as time or the number of scenes, as long as a shifted position from the feature scene can be specified.

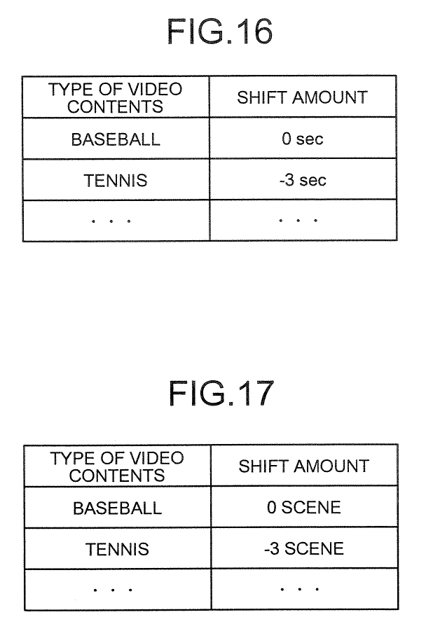

In an example of the shift table 1502 shown in FIG. 16, the types of video contents, such as the baseball and the tennis, are related to the shift amounts represented by time. In another example of the shift table 1502 shown in FIG. 17, the types of video contents are related to the shift amounts represented by the number of scenes.

Upon receiving the instruction for skipping, the playback-position control unit 1506 shifts the playback position to a position shifted by a shift amount corresponding to the type of video contents obtained by the video-contents obtaining unit 1501 from the feature scene that appears first after the current frame.

For some types of video contents, a start point of a semantic unit, which means an ideal target playback point from which the user hopes to watch the video data, can be different from a start point of the feature scene. By changing the target position depending on the type of video contents using the shift amount, it is possible to cause the video data played back from the proper start-point of the semantic unit variable for each type of video contents. If the video data is a baseball-game program, the pitching scene is selected as the feature scene. Because the feature scene starts from a scene showing a set position, from which the pitcher throws the ball, the start point of the semantic unit corresponds with that of the feature scene.

If the video data relates to a tennis-game program, the semantic unit starts from a scene of making a service. However, the scene of making a service is shot by cameras with various positions and angles. Because, according to the first embodiment, the video playback apparatus 1500 selects the scene that appears frequently as the feature scene, the scene of making a service is not selected as the feature scene in most cases. A fixed camera shots a whole tennis court every time before or after the scene of making a service in most cases. Therefore, the scene showing the whole tennis court, which appears away from the scene of making a service, is likely to be selected as the feature scene. To solve the problem, when the video data is a type of video contents like the tennis, the video playback apparatus 1500 skips to a proper position from which the user hopes to watch the video data by shifting the target position to the position shifted by the shift amount counted from the feature scene.

The process in which the video playback apparatus 1500 calculates the target position is described below. The general process of video playback, the scene dividing process, the scene grouping process, the feature-scene selecting process are similar to those according to the first embodiment.

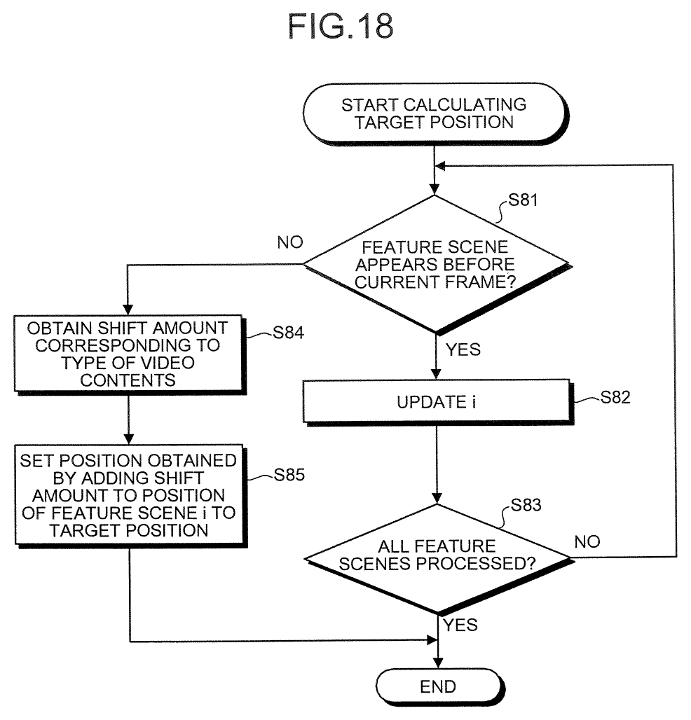

The target position calculating process is described below with reference to FIG. 18. In a flowchart shown in FIG. 18, “i” is an integral number ranging from 1 to N (an initial value of i is 1), representing a feature scene to be processed, where N is the total number of the feature scenes to be processed.

The playback-position control unit 1506 checks whether a feature scene i appears before a current frame (step S81). When the feature scene i appears after the current frame (No at step S81), the playback-position control unit 1506 obtains a shift amount corresponding to the type of video contents obtained by the video-contents obtaining unit 1501 from the shift table 1502 (step S84). The playback-position control unit 1506 sets a position calculated by adding the shift amount to a position of the feature scene i to the target position (i.e., a position to which the playback position is shifted) (step S85).

When the feature scene i appears before the current frame (Yes at step S81), the playback-position control unit 1506 updates i by setting i to i+1 (step S82) to process all the feature scenes as described at steps S81 and S82 (step S83).

As described above, because the video playback apparatus 1500 sets the shift amount for each type of video contents and shifts the target position from the feature scene by the shift amount depending on the type of video contents, it is possible to shift the playback position to a proper start-position variable for each type of video contents from which the user hopes to watch the video data.

A video playback apparatus 1900 according to a third embodiment of the present invention selects a typical feature scene from the feature scenes and shifts the playback position to the selected typical feature scene.

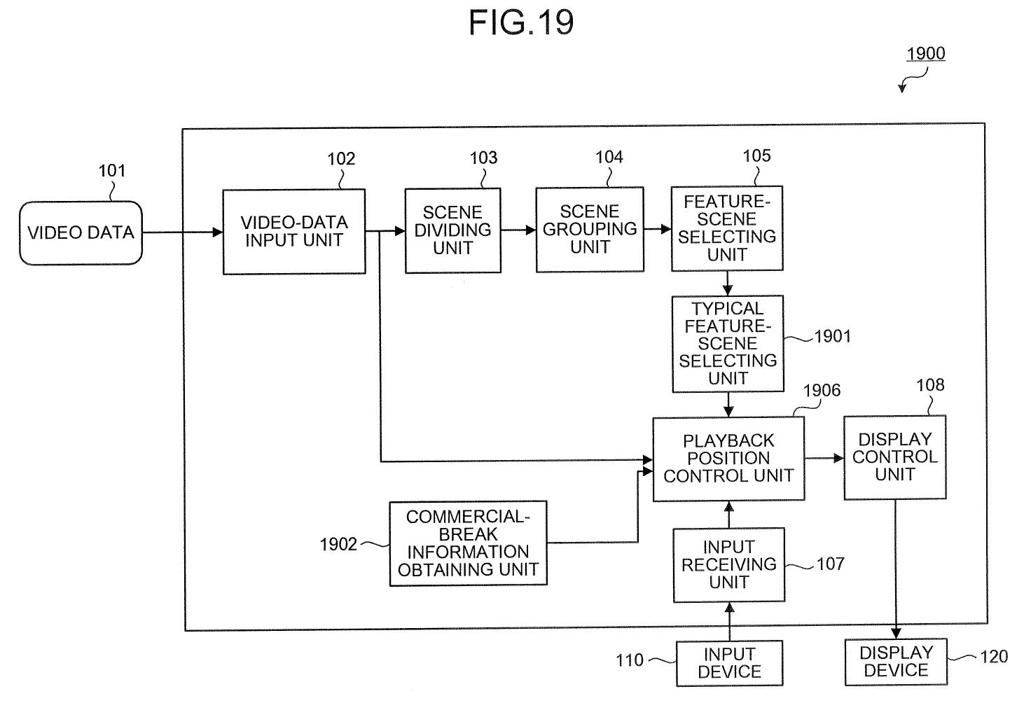

As shown in FIG. 19, the video playback apparatus 1900 includes the video-data input unit 102, the scene dividing unit 103, the scene grouping unit 104, the feature-scene selecting unit 105, a typical feature-scene selecting unit 1901, a playback-position control unit 1906, a commercial-break information obtaining unit 1902, the input receiving unit 107, the display control unit 108, the input device 110 such as a keyboard, a mouse, or a remote controller with various buttons, and the display device 120.

The functions and the configuration of the video-data input unit 102, the scene dividing unit 103, the scene grouping unit 104, the feature-scene selecting unit 105, the input receiving unit 107, the display control unit 108, the input device 110, and the display device 120 are similar to those according to the first embodiment.

The commercial-break information obtaining unit 1902 obtains information on commercial breaks, which are periods other than the program, in the video data. The well-known method for obtaining the commercial-break information can be employed in which a commercial break is specified by checking whether a stereophonic sound is used or a monaural sound is used.

The typical feature-scene selecting unit 1901 determines whether a feature amount (third feature-information) of the feature scene satisfies a fifth criterion, and selects the feature scene with the feature amount that satisfies the fifth criterion as a typical feature scene.

Although a feature amount based on magnitude of sound or time distribution is employed for selecting the typical feature scene dissimilar to the feature amount for grouping the scenes used by the scene grouping unit 104, the feature amount for selecting the typical feature scene is not limited to above. Any feature amount that can specify the typical feature scene from the feature scenes can be employed. Similarly, although a feature amount based on magnitude of sound or time distribution is employed for selecting the feature scenes from which the typical feature-scene is selected dissimilar to the feature amount for grouping the scenes used by the scene grouping unit 104 according to the third embodiment, the feature amount for grouping the scenes used by the scene grouping unit 104 can also be employed.

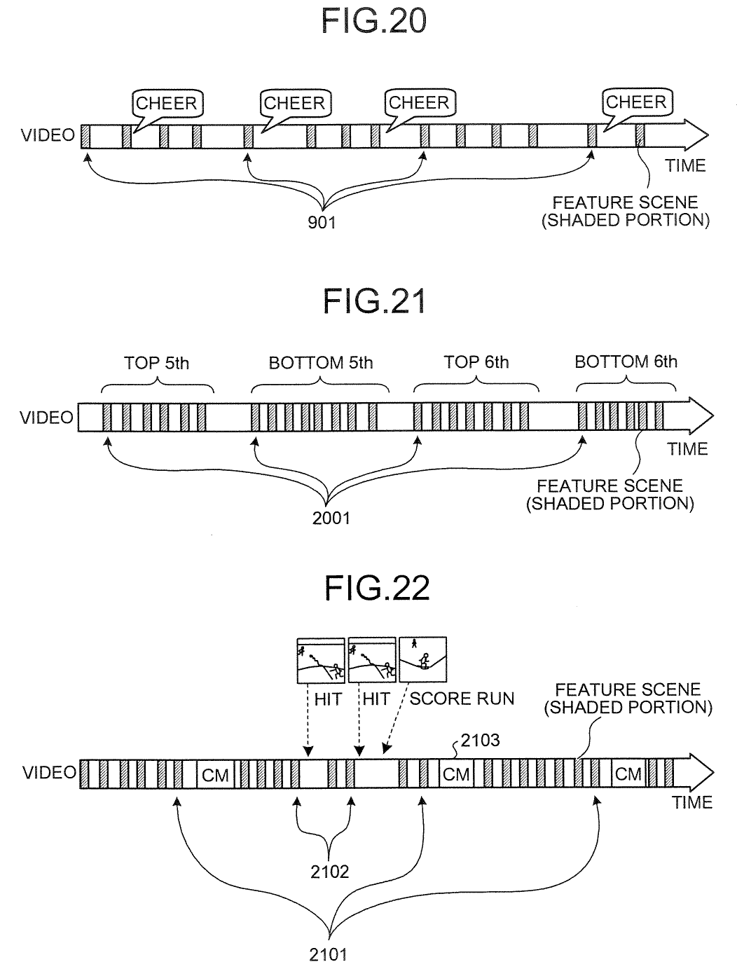

An example using the feature amount based on magnitude of sound is described below with reference to FIG. 20. In the example, a feature scene until whose next feature scene a cheer is given as the typical feature scene.

In the example of the video data of the baseball-game program, the pitching scene is selected as the feature scene, and a pitching-scene until whose next pitching scene a cheer is given is selected as the typical feature scene. In this case, the magnitude of sound between a head frame of the feature scene and a frame immediately before the next feature scene is used as the feature amount. If a sound has a magnitude larger than a predetermined value and lasts longer than a predetermined time, the voice is determined to satisfy the fifth criterion. According to the fifth criterion, scenes 901, each of which is the feature scene until whose next feature scene a cheer is given, are selected from the feature scenes represented in shade as the typical feature scenes

Another example using a feature amount based on time distribution is described below with reference to FIG. 21.

In the example, density of time distribution of the pitching scene (i.e., the feature scene), is used as a feature amount. The pitching scenes are grouped based on the feature amount, and a head pitching scene of a group is selected as the typical feature scene. It means that the pitching scenes are grouped for each half-inning based on the interval between the pitching scenes, and a head pitching scene of each group (i.e., a pitching scene 2001), which is the pitching scene for a lead-off batter, is selected as the typical feature scene. In the example, it is possible to browse the baseball-game program using a half-inning unit.

In the example, the density of time distribution of the feature scenes used as the feature amount is, more particularly, the interval between the feature scenes. When the interval is equal to or longer than a predetermined time, the typical feature-scene selecting unit 1901 determines that the interval satisfies the fifth criterion.

Although the head feature scene of each group is selected as the typical feature scene in the above example, the typical feature scene is not limited to above. It is allowable to select the last feature scene of each group as the typical feature scene.

An example using another feature amount based on time distribution is described below with reference to FIG. 22. In the example, the last pitching scene of a big group of pitching scenes is selected as the typical scene.

In the example, it is possible to detect a pitching scene 2101, which is the last pitching scene of each half-inning, and a pitching scene 2102, after which an event such as a hit happens. It is possible skip only to the pitching scene 2102 by removing commercial breaks 2103, which, if the baseball-game program is a commercial broadcasting program, likely appear during a teams-switching period at each inning, using the commercial-break information obtained by the commercial-break information obtaining unit 1902.

In other words, in the example, the feature amount is the density of time distribution of the pitching scenes in the video data with the commercial breaks excluded by the commercial-break information obtaining unit 1902, and the typical feature scene to be selected is the last pitching scene of each group of pitching scenes that is grouped based on the above feature amount. A process for excluding the commercial breaks can be performed before the typical feature-scene selecting process or at a step of determining the feature amount in the typical feature-scene selecting process.

Although the last feature scene of each group is selected as the typical feature scene in the above example, the typical feature scene is not limited to above. It is allowable to select the head feature scene of each group as the typical feature scene.

Upon receiving the instruction for skipping from the user, the playback-position control unit 1906 shifts the playback position to a frame corresponding to the target typical feature scene.

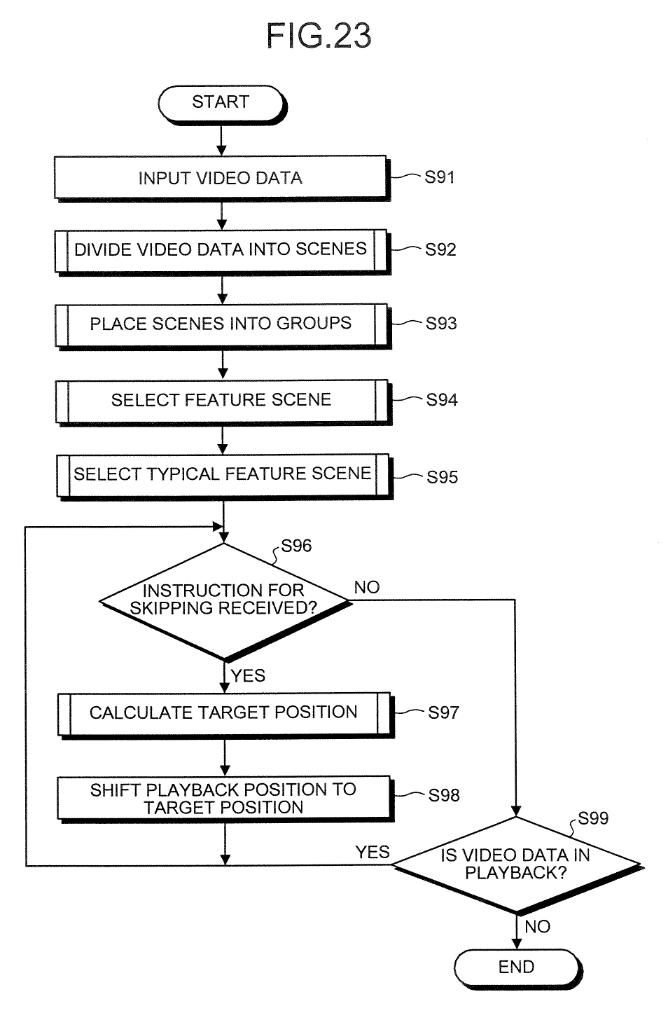

A video playback process by the video playback apparatus 1900 is described below with reference to FIG. 23.

According to the third embodiment, the steps of the video-data inputting process, the scene dividing process, the scene grouping process, and the feature scene selecting process (steps S91 to S94) are similar to the corresponding steps according to the first embodiment. After those steps, the typical feature-scene selecting unit 1901 performs the typical feature-scene selecting process (step S95). The steps after step S95 are similar to the corresponding steps according to the first embodiment.

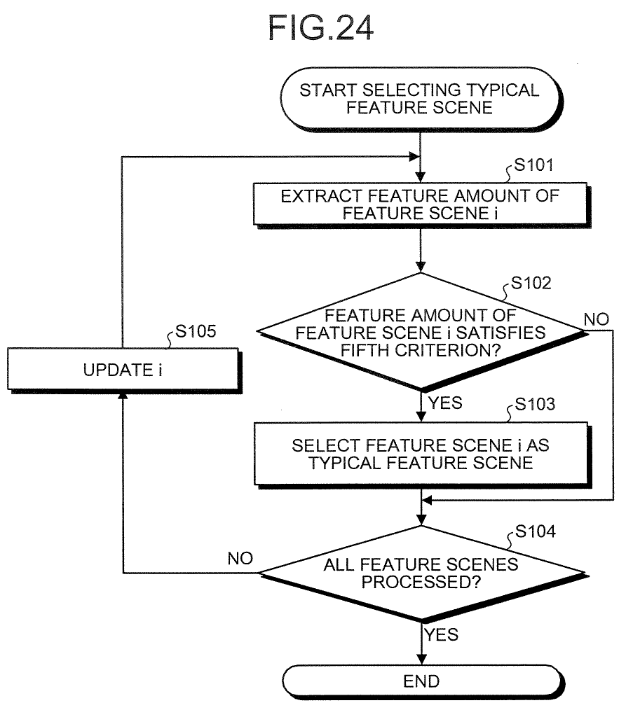

The typical feature-scene selecting process at step S95 is described with reference to FIG. 24. In a flowchart shown in FIG. 24, “i” is an integral number ranging from 1 to N (an initial value of i is 1), representing a feature scene to be processed, where N is the total number of the feature scenes to be processed.

The typical feature-scene selecting unit 1901 extracts the feature amount of a feature scene i (step S101), and checks whether the extracted feature amount satisfies the fifth criterion (step S102).

When the feature amount satisfies the fifth criterion (Yes at step S102), the typical feature-scene selecting unit 1901 selects the feature scene i as the typical feature scene (step S103). When the feature amount doesn't satisfy the fifth criterion (No at step S102), the typical feature-scene selecting unit 1901 doesn't select the feature scene i as the typical feature scene.

The typical feature-scene selecting unit 1901 checks whether all the feature scenes have been processed as described at steps S101 to S103 (step S104). When not all the feature scenes have been processed, the typical feature-scene selecting unit 1901 updates the feature scene by setting i to i+1 (step S105) to process the next scene as described at steps S101 to S103. When all the feature scenes have been processed, the typical feature-scene selecting unit 1901 ends the process. As a result of the above process, the typical feature scene has been selected, and the playback-position control unit 1906 has shifted the playback position to a frame corresponding to the typical feature scene.

As described above, the video playback apparatus 1900 selects the typical feature scene from the feature scenes based on the feature amount and shifts the playback position to the target typical feature scene. Therefore, it is possible to shift the playback position to a proper position from which the user hopes to watch the video data.

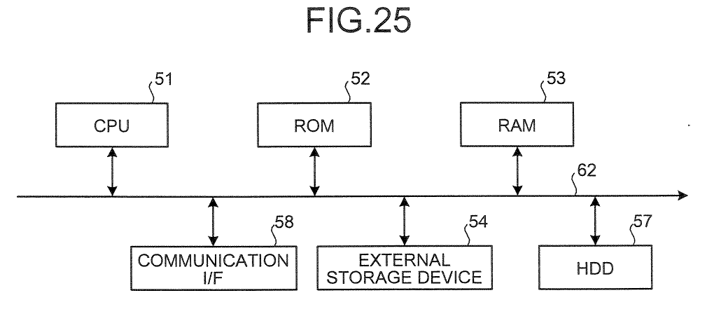

As shown in FIG. 25, the video playback apparatus according to the first to the third embodiments includes a control device such as a central processing unit (CPU) 51, storage devices such as a read only memory (ROM) 52 and a random access memory (RAM) 53, a HDD 57, an external storage device 54 such as a DVD drive, and a communication interface 58, all of which connected to each other via a bus 62. In addition, the video playback apparatus includes the display device 120 and the input device 110. The video playback apparatus has a hardware configuration using an ordinal computer.

A video playback program executed by video playback apparatus according to the first to the third embodiments is provided in a form of an installable or an executable file stored in a computer-readable storage medium such as a compact disk-read only memory (CD-ROM), a flexible disk (FD), a compact disk recordable (CD-R), and a digital versatile disk (DVD).

The video playback program can be stored in a computer connected to a network like the Internet, and downloaded to another computer via the network. In addition, the video playback program can be delivered or distributed via a network such as the Internet.

Furthermore, the video playback program can be preinstalled in a storage medium such as a ROM.

The video playback program is made up of modules such as the scene dividing unit, the scene grouping unit, the feature scene selecting unit, the playback-position control unit, the typical feature-scene selecting unit, and the video-contents obtaining unit. As an actual hardware configuration, when the CPU (processor) reads the video playback program from the above storage medium and executed the read program, the above units are loaded and created on a main memory.

Although the video playback apparatus is applies to an ordinary computer according to the first to the third embodiments, the application is not limited to above. The present invention can be applied to devices dedicated to video playback such as a DVD playback device, a video playback device, and a digital-broadcast playback device. In the case, the video playback apparatus can exclude the display device 120.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for playing back a video, comprising:
a first feature information calculating unit that calculates a first feature information representing a feature of each of frames of input video data;
a scene dividing unit that divides the input video data into scenes based on similarity of the first feature-information between the frames;
a second feature information calculating unit that calculates a second feature-information representing a feature of each of the scenes;
a scene grouping unit that classifies the scenes into groups based on similarity of second feature-information between scenes;
a feature-scene selecting unit that selects a feature scene that appears repeatedly in the video data;
an input receiving unit that receives a shift command; and
a playback-position control unit that shifts, when the shift command is received, a playback position to a frame of the feature scene that appears first after a current frame.

2. The apparatus according to claim 1, wherein the feature-scene selecting unit determines the feature scene satisfies a first criterion and selects the feature scene in case:
(A) the number of scenes in the specific group containing the feature scene is more than a threshold;
(B) a sum of playback time of the specific group containing the feature scene is more than a threshold;
(C) a ratio of the number of the scenes in the specific group containing the feature scene to a total number of the scenes in the video data is more than a threshold; or
(D) a ratio of the sum of playback time of the specific group containing the feature scene to a total playback time of the video data is more than a threshold.

3. The apparatus according to claim 2, wherein the feature-scene selecting unit determines whether a time-distribution overlap between the scene that satisfies the first criterion and a scene that has already selected as the feature scene satisfies a third criterion, and when it is determined that the overlap satisfies the third criterion, selects the scene that satisfies the first criterion as the feature scene.

4. The apparatus according to claim 1, wherein a scene right before the feature scene that appears first after the current frame satisfies a fourth criterion, the playback-position control unit shifts the playback position to the scene right before the feature scene that appears first after the current frame.

5. The apparatus according to claim 1, further comprising:
a shift-information storage unit that stores shift information in which a shift amount counted from the feature scene is associated with a type of video contents for the video data;
a video-contents obtaining unit that obtains the type of video contents for the video data, wherein
the playback-position control unit shifts the playback position to a position shifted by a shift amount corresponding to obtained the type of video contents from the frame of the feature scene that appears first after the current frame.

6. The apparatus according to claim 1, further comprising a typical feature-scene selecting unit that determines whether a third feature-information, which represents a feature of the feature scene, satisfies a fifth criterion, and when it is determined that the third feature-information satisfies the fifth criterion, selects the feature scene as a typical feature scene, wherein
the playback-position control unit shifts the playback position to a frame of the typical feature scene.

7. The apparatus according to claim 6, wherein the third feature-information is audio information included in the video data.

8. The apparatus according to claim 6, wherein
the third feature-information is density of time distribution of the feature scene, and
when it is determined that the density of time distribution of the feature scene satisfies the fifth criterion, the typical feature-scene selecting unit selects either a first feature scene or a last feature scene of feature scenes grouped based on the density of time distribution as the typical feature scene.

9. The apparatus according to claim 8, further comprising a commercial-break information obtaining unit that obtains a commercial break in the video data, wherein
the third feature-information is density of time distribution of the feature scene the video data from which the commercial break is excluded.

10. A method of playing back a video, comprising:
calculating a first feature information representing a feature of each of frames of input video data;
dividing the input video data into scenes based on similarity of the first feature-information between the frames;
calculating a second feature-information representing a feature of each of the scenes;
classifying the scenes into groups based on similarity of second feature-information between scenes;
selecting a feature scene that appears repeatedly in the video data;
receiving a shift command; and
shifting, when the shift command is received, a playback position to a frame of the feature scene that appears first after a current frame.

11. A computer program product comprising a computer-usable medium having computer-readable program codes embodied in the medium that when executed cause a computer to execute:
calculating a first feature information representing a feature of each of frames of input video data;
dividing the input video data into scenes based on similarity of the first feature-information between the frames;
calculating a second feature-information representing a feature of each of the scenes;
classifying the scenes into groups based on similarity of second feature-information between scenes;
selecting a feature scene that appears repeatedly in the video data;
receiving a shift command; and
shifting, when the shift command is received, a playback position to a frame of the feature scene that appears first after a current frame.
